(19) United States
(12) Patent Application Publication
(10) Pub. No.: US 2007/0204624 A1
(43) Pub. Date: Sep. 6, 2007

(54) Fuel injector for a turbine engine

(76) Inventors: Kenneth O. Smith, San Diego, CA (US); Partha Dutta, San Diego, CA (US)

Correspondence Address: Caterpillar Inc.;Intellectual Property Dept., AB 6490, 100 N.E. Adams Street, PEORIA, IL, 61629-6490, US

(21) Appl. No.: 11/365,435

(22) Filed: Mar. 1, 2006

(51) Int. Cl. F02C 7/22

(52) U.S. Cl. 60/773; 60/740

(57) ABSTRACT

To meet emissions standards, many gas turbine engines use some form of lean, pre-mixed combustion system. The lean nature of the fuel may lead to combustion oscillations or other instabilities. A fuel injector having an inner and outer cylinder receives pilot fuel and a portion of pre-mixed fuel-air into an annular space defined by the inner and outer cylinders. The amount of pilot fuel mixed with the pre-mixed fuel-air can be modulated based on sensed conditions within the turbine engine. Continuous modulation of the pilot fuel to adapt to the sensed conditions improves main burner flames and response to engine transients.

### TECHNICAL FIELD

The present invention is directed to an apparatus, system, and method for burning a mixture of fuel and air. More particularly, the present invention is directed to an apparatus, system, and method for burning a mixture of fuel and air in a gas turbine engine.

### BACKGROUND

Internal combustion engines, including diesel engines, gaseous-fueled engines, and other engines known in the art, may exhaust a complex mixture of air pollutants. These air pollutants may be composed of gaseous compounds, which may include nitrous oxides (NOx). Due to increased attention on the environment, exhaust emission standards have become more stringent and the amount of NOx emitted to the atmosphere from an engine may be regulated depending on the type of engine, size of engine, and/or class of engine.

It has been established that a well-distributed, low temperature flame can reduce NOx production. One way to generate a well-distributed, low temperature flame is to premix fuel and air to a predetermined lean fuel-to-air ratio. However, at lean fuel-to-air ratios, combustion instabilities may occur, such as combustion pressure oscillations, for example.

Burners for gas turbine engines have become more sophisticated to overcome these instabilities while still providing low NOx emissions. For example, U.S. Pat. No. 6,971,242 to Boardman, dated Dec. 6, 2005, teaches a burner that uses offset orifices on radially positioned first and second cylinders to stabilize flame propagation within a combustion chamber. Specifically, the unique arrangement of orifices helps reduce combustion oscillations, which allows the combustor to run at conditions that result in low NOx.

Although this unique arrangement helps reduce NOx, the pilot fuel remains rich, and when used to provide a steady flame, increases the amount of NOx that the engine produces.

The disclosed burner is directed to overcoming one or more of the problems set forth above.

### SUMMARY OF THE INVENTION

In one aspect, the present disclosure is directed to a fuel injector for a turbine engine. The fuel injector includes a first cylinder, and a second cylinder positioned radially outward from the first cylinder. The first cylinder includes at least one of a first orifice and communicates a main fuel to a combustion chamber. The first and second cylinders form an annular space there between, which is in communication with the at least one of a first orifice. The annular space is adapted to receive both pilot fuel and main fuel from the first cylinder. A combined main fuel/pilot fuel mixture exits through at least one of a second orifice in the second cylinder to the combustion chamber to form a stable pilot flame.

In another aspect, the present invention is directed to a combustion system for a turbine engine having a combustor liner, a source of main fuel, a source of pilot fuel, and at least one fuel injector positioned within the combustor liner. The fuel injector includes a first cylinder having at least one of a first orifice, and in communication with the source of main fuel, and a second cylinder positioned radially outward from the first cylinder. The first and second cylinders form a space there between and communicate with the source of main fuel through the at least one of a first orifice and the source of pilot fuel. The second cylinder also includes at least one of a second orifice in communication with the space and communicates a main fuel/pilot fuel mixture to the combustion chamber.

In yet another aspect, the present invention is directed to a method of burning a fuel in a turbine engine. The method includes the steps of supplying a main fuel to a first cylinder, supplying a pilot fuel to a space between the first cylinder and the second cylinder, flowing a portion of the main fuel through at least one of a first orifice to the space between the first cylinder and the second cylinder, mixing the pilot fuel with the portion of the main fuel within the space, and passing the mixed main fuel/pilot fuel through at least one of a second orifice into a combustion chamber.

### BRIEF DESCRIPTION OF THE DRAWINGS

FIG. 1 is a schematic representation of a gas turbine engine including an exemplary embodiment of the present invention;

FIG. 2 is a side view illustration of an exemplary fuel injector according to one embodiment of the present invention; and

FIG. 3 is a side cross-sectional illustration of a burner of the fuel injector of FIG. 2 according to one embodiment of the present invention.

### DETAILED DESCRIPTION

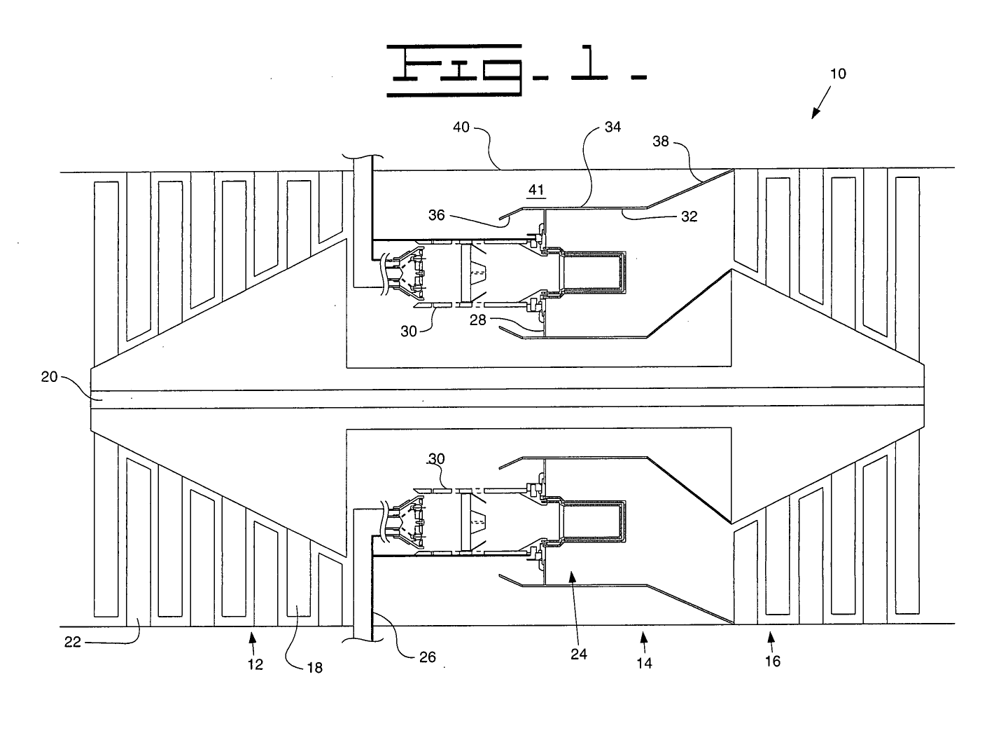

FIG. 1 shows a turbine engine 10. The turbine engine 10 may be associated with a stationary or mobile work machine configured to accomplish a predetermined task. For example, the turbine engine 10 may embody the primary power source of a generator set that produces an electrical power output or of a pumping mechanism that performs a fluid pumping operation. The turbine engine 10 may alternatively embody the prime mover of an earth-moving machine, a passenger vehicle, a marine vessel, or any other mobile machine known in the art.

The turbine engine 10 includes a compressor section 12, a combustion system 14, and a turbine section 16. The compressor section 12 may include components rotatable to compress inlet air. Specifically, the compressor section 12 may include a series of rotatable compressor blades 18 fixedly connected about a central shaft 20. As the central shaft 20 rotates, the compressor blades 18 draw air into the turbine engine 10 and pressurize the air. This pressurized air may then be directed toward the combustion system 14 for mixture with a liquid and/or gaseous fuel. It is contemplated that the compressor section 12 may further include compressor blades 22 that are separate from the central shaft 20 that remain stationary during operation of the turbine engine 10.

The combustor section 14 may mix fuel with the compressed air from the compressor section 12 and combust the mixture to create a mechanical work output. Specifically, the combustor section 14 may include an annular combustion chamber 24, a fuel supply line 26, a dome 28, and a plurality of fuel injectors 30 annularly arranged about the central shaft 20. The fuel supply line feeds main fuel into the fuel injectors 30.

Each fuel injector 30 may inject one or both of liquid and gaseous fuel into the flow of compressed air from the compressor section 12 for ignition within the combustion chamber 24. As the fuel/air mixture combusts, the heated molecules expand and move at high speed into the turbine section 16.

The combustor chamber 24 includes a hot side 32, a cold side 34, a first portion 36 and a second portion 38. The hot side 32 defines a combustion zone, while the cold side 34, along with a housing 40, defines an air channel 41. The dome 28 may attach to the hot side 32 proximate the first portion 36.

The turbine section 16 fluidly connects with the combustion system 14 and receives a mass of exhaust gas (not shown) from the combustion system 14. The mass of exhaust gas expands through the turbine section 16. The compressor section 12 and the turbine section 16 connect through the shaft 20 between the turbine section 16 and the compressor section 12. Other conventional methods for transmitting a force may include a hydraulic accumulator/motor, electric motor/generator, and gear systems.

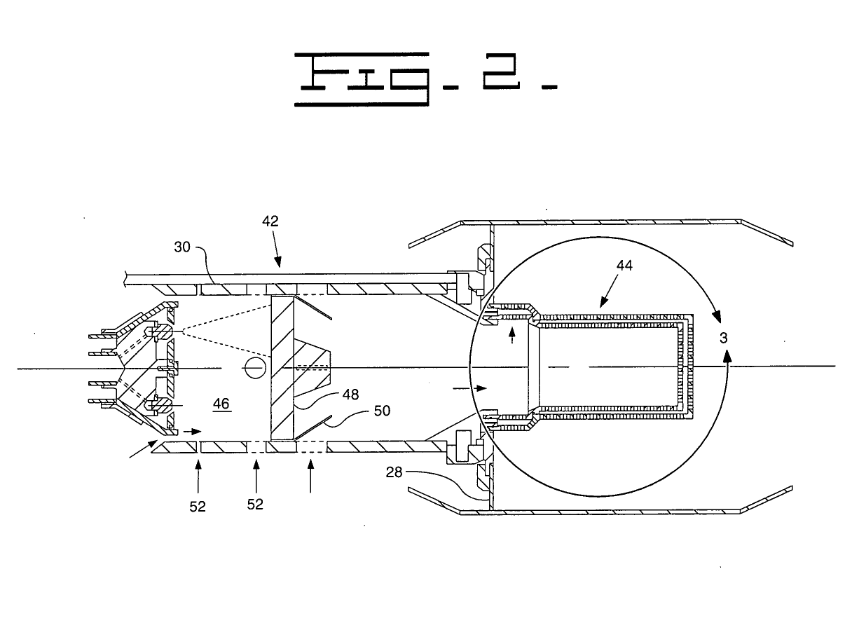

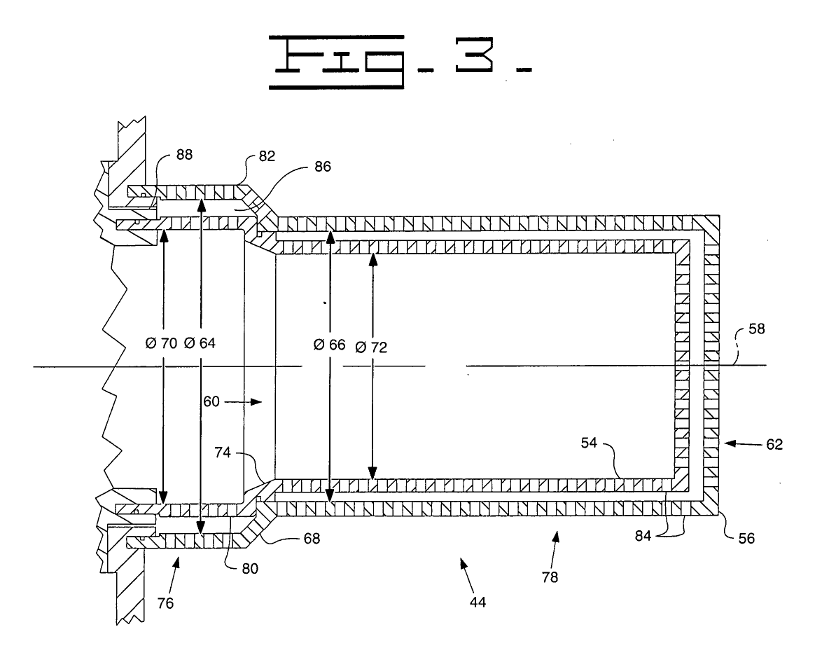

As shown in FIGS. 2 and 3, the fuel injector 30 includes a mixing section 42 and a burner section 44. The mixing section 42 includes a mixing conduit 46, which includes a fluid mixing means 48 for mixing the fuel with the mass of compressed air. In the present embodiment, the fluid mixing means 48 may include a plurality of vortex generator tabs 50, but may embody any type of mixing device known in the art, such as a swirler, for example.

The fluid conduit 46 may also include mixing orifices 52 positioned along the mixing conduit 46, upstream of the dome 28 to introduce a portion of the mass of compressed air. The mixing orifices 52 may introduce the portion of compressed air with a tangential component of velocity with respect to the incoming main fuel.

The burner section 44 includes an inner cylinder 54 and an outer cylinder 56 positioned about a central axis 58. Each of the inner and outer cylinders 54, 56 include a first open end portion 60 and a second end portion 62, which may be open or closed. In the present application, the term cylinder means a vessel having a volume that may at least partially bound a fluid and may have an irregularly shaped profile other than a rectangle. In the illustrated embodiment, the outer cylinder 56 comprises two separate diameters 64, 66 with an angled surface 68 between them. Similarly, the inner cylinder 54 comprises two separate diameters 70, 72 with an angled surface 74 between them. The outer cylinder 56 is displaced radially outward from the inner cylinder 54.

The burner section 44 further includes a pilot section 76 and a main burner section 78. The larger diameters 70, 64 of the inner and outer cylinders 54, 56 comprise the pilot section 76, while the smaller diameters 72, 66 of the inner and outer cylinder 54, 56, respectively comprise the main burner section 78. Within the pilot section 76, the inner cylinder 54 includes a first array of orifices 80 and the outer cylinder includes a second array of orifices 82. The orifices 80, 82 may be offset from each other. Each of the inner and outer cylinders 54, 56 of the main burner section 78 may also include a multiplicity of orifices 84.

The inner and outer cylinders 54, 56 define therein between an annular space 86 in communication with the first and second arrays of orifices 80, 82 and a pilot fuel feed 88. The annular space 86 is positioned within the pilot section 76. A pilot fuel source (not shown) provides pilot fuel to the annular space 76 between the inner and outer cylinders 54, 56 through the pilot fuel feed 88.

The annular space 86 receives pilot fuel from the pilot fuel source and premixed fuel-air mixture from the fluid conduit 46, which also feeds the main burner section 78. Within the annular space 86, the pilot fuel and premixed fuel-air mixture combine before passing through the second array of orifices 82 of the outer cylinder 56.

A control module (not shown) monitors conditions within the combustion system 14 to detect instabilities and irregularities, which may result from improper fuel/air ratio, oscillations, or other conditions that may create NOx or damage to the turbine engine 10. Upon detection of these instabilities, the control module may modulate amounts of pilot fuel into the annular space 86 to change the pilot mixture. For example, if the control module detects oscillations, additional pilot fuel may be passed through the annular space 86 to provide a more stable pilot flame. Similarly, the amount of pilot fuel may be increased during start-up and reduced during steady-state operation. Preferably, the majority of the pilot flame uses the premixed fuel-air mixture, however, continuous operation of the pilot fuel improves stability of the main burner flames and response to engine transients.

### INDUSTRIAL APPLICABILITY

The disclosed fuel injector 30 may be applicable to any turbine engine 10 where reduced oscillations and emissions within the turbine engine are desired. Although particularly useful for low NOx-emitting engines, the disclosed fuel injector may be applicable to any turbine engine regardless of the emission output of the engine.

Fuel enters through the mixing conduit 46, where it may be atomized using one of numerous techniques, such as air blast atomization. As the fuel moves through the mixing conduit 46, compressed air from the compressor section 12 enters through the array of mixing orifices 52 creating a swirling motion causing the fuel to become entrained in the swirling compressed air to create a mixture of fuel and air. The fuel-air mixture accelerates as it passes into the burner section 44 of the fuel injector 30.

Upon entering the burner section 44, a portion of the fuel-air mixture passes through the first array of orifices 80 of the inner cylinder 54 into the annular space 86 and mixes with the pilot fuel. The pilot fuel and fuel-air mixture combine and pass through the second array of orifices 82 to provide a stable pilot flame. Continuous modulation of the pilot fuel, or continuous monitoring of conditions within the turbine engine 10, improves stability of the main burner flames and better response to engine transients.

It will be apparent to those skilled in the art that various modifications and variations can be made to the disclosed fuel injector. Other embodiments will be apparent to those skilled in the art from consideration of the specification and practice of the disclosed fuel injector. It is intended that the specification and examples be considered as exemplary only, with a true scope being indicated by the following claims and their equivalents.

What is claimed is:

1. A fuel injector for a gas turbine engine, comprising:
a first cylinder having at least one of a first orifice, the first cylinder adapted to communicate a main fuel to a combustion chamber;
a second cylinder positioned radially outward from the first cylinder and forming an annular space there between in communication with the at least one of a first orifice, the annular space adapted to receive pilot fuel and main fuel, the second cylinder including at least one of a second orifice in communication with the space and adapted to communicate a main fuel/pilot fuel mixture to the combustion chamber.

2. The fuel injector according to claim 1, wherein the at least one of a first orifice is offset from the at least one of a second orifice.

3. The fuel injector according to claim 1, wherein the pilot fuel enters the space flowing substantially perpendicular to the flow of the main fuel through the at least one of a first orifice.

4. The fuel injector according to claim 2, wherein the first and second cylinders comprise a plurality of first orifices and a plurality of second orifices, respectively.

5. The fuel injector according to claim 1, wherein the burner includes a pilot section and a main burner section, and wherein an inner diameter of the pilot section is greater than an inner diameter of the main burner section, and wherein the annular space is positioned at the pilot section.

6. The fuel injector according to claim 5, wherein the outer cylinder includes an angled surface connecting the pilot section to the main burner section, and wherein the angled surface includes the at least one of a second orifice.

7. The fuel injector according to claim 1, further comprising a pilot fuel feed positioned to provide pilot fuel into the annular space.

8. A combustion system for a turbine engine comprising:
a combustor liner;
a source of main fuel;
a source of pilot fuel;
at least one fuel injector positioned within the combustor liner, the burner including;
a first cylinder having at least one of a first orifice and in communication with the source of main fuel;
a second cylinder positioned radially outward from the first cylinder and forming a space there between in communication with the source of main fuel through the at least one of a first orifice and the source of pilot fuel, the second cylinder including at least one of a second orifice in communication with the space and adapted to communicate a main fuel/pilot fuel mixture to the combustion chamber.

9. The combustion system according to claim 8, wherein the at least one of a first orifice is offset from the at least one of a second orifice.

10. The combustion system according to claim 8, wherein the pilot fuel enters the space flowing substantially perpendicular to the flow of the main fuel through the at least one of a first orifice.

11. The combustion system according to claim 9, wherein the first and second cylinders comprise a plurality of first orifices and a plurality of second orifices, respectively.

12. The combustion system according to claim 8, wherein the burner includes a pilot section and a main burner section, and wherein an inner diameter of the pilot section is greater than an inner diameter of the main burner section, and wherein the annular space is positioned at the pilot section.

13. The combustion system according to claim 12, wherein the outer cylinder includes an angled surface connecting the pilot section to the main burner section, and wherein the angled surface includes the at least one of a second orifice.

14. The combustion system according to claim 8, further comprising a pilot fuel feed positioned to provide pilot fuel into the annular space.

15. The combustion system according to claim 14, further comprising a control module configured to modulate an amount of pilot fuel from the pilot supply under predetermined conditions.

16. The combustion system according to claim 15, wherein the control module modulates the amount of pilot fuel into the annular space based on at least one of a sensed transient operation and a start-up condition.

17. A method of burning a fuel in a turbine engine, comprising the steps of:
supplying a main fuel to a first cylinder;
supplying a pilot fuel to a space between the first cylinder and the second cylinder;
flowing a portion of the main fuel through at least one of a first orifice to the space between the first cylinder and the second cylinder;
mixing the pilot fuel with the portion of the main fuel within the space; and
passing the mixed main fuel/pilot fuel through at least one of a second orifice into a combustion chamber.

18. The method according to claim 17, further comprising the step of simultaneously passing the main fuel through the first cylinder into the combustion chamber.

19. The method according to claim 17, further comprising the step of modulating the amount of pilot fuel to the space based on predetermined conditions.
